(19) United States
(12) Patent Application Publication
(10) Pub. No.: US 2006/0006980 A1
(43) Pub. Date: Jan. 12, 2006

(54) Protection mechanism for switches

(76) Inventor: Tsung-Mou Yu, Panchiao City (TW)

Correspondence Address: SUPREME PATENT SERVICES, POST OFFICE BOX 2339, SARATOGA, CA, 95070, US

(21) Appl. No.: 10/889,243

(22) Filed: Jul. 10, 2004

(51) Int. Cl. H01H 71/16

(52) U.S. Cl. 337/66

(57) ABSTRACT

A protection mechanism for a switch device includes a pivotably member pivotably connected to an underside of the switch member pivotably connected to an open top of the case of the switch device. The pivotable member includes a shorter tongue and two rods. An end of the bimetallic plate is inserted between the two rods and the tongue so that when the switch member is pressed on one end, the bimetallic plate is lifted to set the switch device to “OFF” position. When the switch member is pressed on the other end, the pivotable member is lowered and the tongue pushes the bimetallic plate to “ON” position. The pivotable member is pivoted an angle and moved toward a space in the case so that the tongue is shifted a distance such that the bimetallic plate is not stopped by the tongue when it is deformed due to overload.

### FIELD OF THE INVENTION

The present invention relates to a protection mechanism for a switch device wherein the bimetallic plate can be deformed completely when overload.

### BACKGROUND OF THE INVENTION

The conventional circuit breaker uses a fuse between the switch and the circuit such that when there is an electrical overload, the fuse will first melt before the overload causes damages. However, if the fuse is not properly installed or an improper fuse is used the overload current cannot melt the fuse and a disaster can be resulted. U.S. Pat. Nos. 5,262,748, 4,167,720, 4,937,548, 5,223,813, 5,451,729, and 5,558,211 disclose different types of circuit breakers which commonly include a complicated mechanism to drive the bimetallic plate which is expected to be deformed and bent when overload in current. Nevertheless, it is noted that the bimetallic plate does not completely deformed as desired because it is not passable to freely deformed, and is still in contact with the terminal so that sparks could be produced and therefore cause disaster.

Therefore, it is desired to have a protection mechanism for a switch device that includes a pivotable member with a shorter tongue and the pivotable member is pivoted an angle when the switch device is in “ON” position, the bimetallic plate is deformed upward and not stopped by the shorter tongue.

### SUMMARY OF THE INVENTION

In accordance with an aspect of the present invention, there is provided a switch device that comprises a case having a switch member pivotably engaged with an open top of the case and a connection port is connected to the switch member. A first terminal and a second terminal respectively extend through a bottom of the case. A bimetallic plate has a first end fixed to the first terminal and a first contact point is connected to a second end of the bimetallic plate. A second contact point is connected to the second terminal and located beneath the first contact point. A protection mechanism includes a pivotable member pivotably connected to the connection port of the switch member and including two rods extending from a first side of the pivotable member. A tongue is pivotably connected to the pivotable member and located above the two rods. The second end of the bimetallic plate is located between the two sides and the tongue so that the second end of the bimetallic plate can be lifted to set the switch device to “OFF” position. The. pivotable member is rotated an angle and pushes the second end of the bimetallic plate downward to set the switch device to “ON” position. The second end of the bimetallic plate is deformed upward and not stopped by the tongue when overload.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 shows the “OFF” status of a switch device of the present invention;

FIG. 2 shows the “ON” status of the switch device of the present invention;

FIG. 3 shows that a bimetallic plate is deformed due to overload and a second end of the bimetallic plate is not stopped by the tongue, and

FIG. 4 is an exploded view to show the switch device of the present invention.

### DETAILED DESCRIPTION OF THE PREFERRED EMBODIMENT

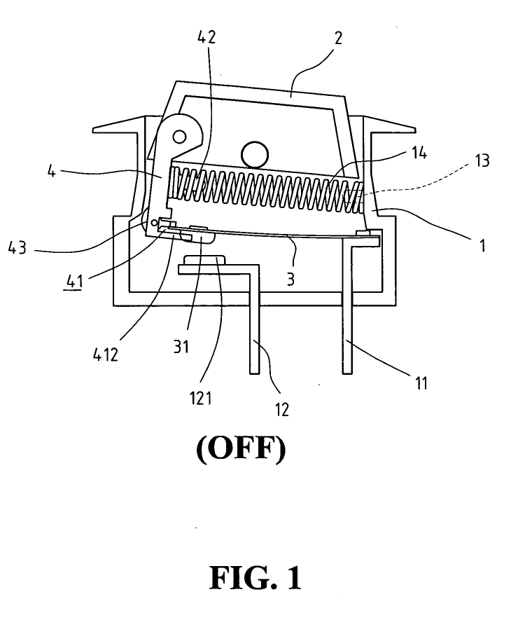

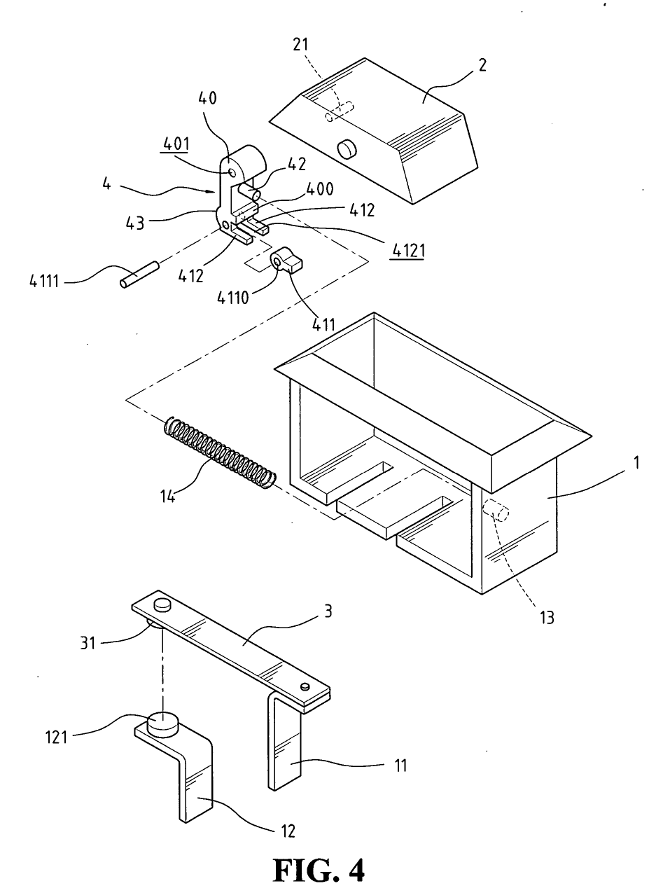

Referring to FIGS. 1-4, a switch device of the present invention comprises a case 1 having an open top and a switch member 2 is pivotably engaged with the open top of the case. A connection port is connected to an underside of the switch member 2 and the connection port is a rod 21 in this embodiment. The case 1 includes a first protrusion 13 extending from an inside thereof.

A first terminal 11 and a second terminal 12 respectively extend through a bottom of the case 1. A bimetallic plate 3 has a first end fixed to the first terminal 11 and a first contact point 31 is connected to a second end of the bimetallic plate 3. A second contact point 121 is connected to the second terminal 12 and located beneath the first contact point 31.

A protection mechanism includes a pivotable member 4, which includes a connection portion 40 and a passage 401 is defined through the connection portion 40 at an end of the pivotable member 4. The pivotable member 4 pivotably connected to the connection port of the switch 2 by inserting the rod 21 of the connection port in the passage 401. Two rods 412 extend from a first side of the pivotable member 4 and a tongue 411 is pivotably connected to the pivotable member 4 and located above the two rods 412. The tongue 411 is shorter than the two rods 412. The tongue 411 includes a through hole 4110 in one end thereof and a pin 4111 extends through the pivotably member 4 and the through hole 4110, so that the tongue 411 is pivotable in a space defined between the two rods 412. The second end of the bimetallic plate 3 located in the space 41 between the two sides 412 and the tongue 411. The pivotable member 4 includes a flange 400 extending form the first side thereof and the tongue 411 is located below the flange 400 so that the flange 400 prevents the tongue 411 from being pivoted upward.

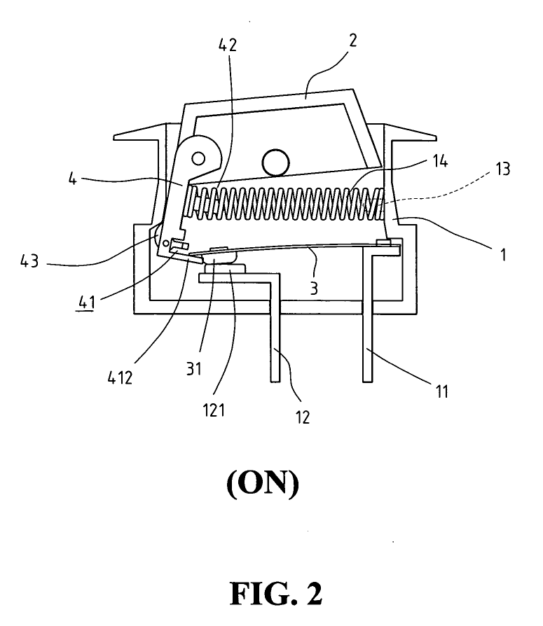

A first protrusion 13 extends from an inside of the case 1 and the pivotable member 4 includes a second protrusion 42 extending from the first side thereof. A spring 14 has its two ends mounted to the first and second protrusions 13, 4 respectively. A convex 43 extends from a second side of the pivotable member 4 and the convex 43 is in contact with an inside of the case 1 by the spring 14. As shown in FIG. 1, the second end of the bimetallic plate 3 is lifted by the two rods 412 to set the switch device to “OFF” position when the right end of the switch member 2 is pressed. As disclosed in FIG. 2 when pressing the left end of the switch member 2, the pivotable member 4 is rotated an angle and the tongue 411 pushes the second end of the bimetallic plate 3 downward to set the switch device to “ON” position. The pivotable member 4 is pivoted to move the convex 43 in a recess in the case 1 when the switch device is in “ON” position, the tongue 411 is moved with the pivotable member 4 toward left as shown in FIG. 2.

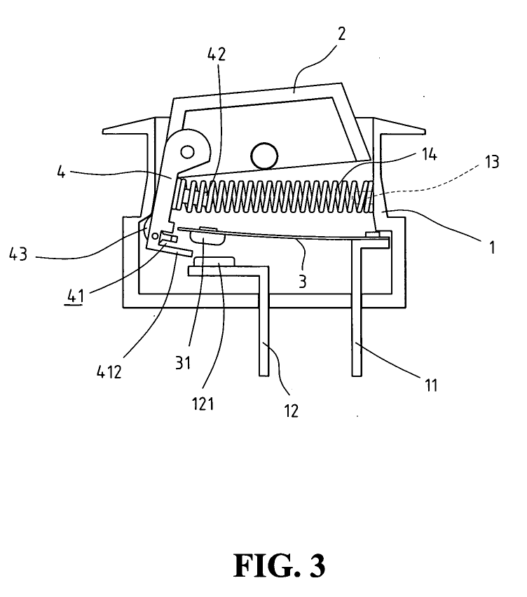

When the switch device is suffered by overload, as shown in FIG. 3, the second end of the metallic plate 3 is deformed upward and not stopped by the tongue 411 which is shifted to left.

While we have shown and described the embodiment in accordance with the present invention, it should be clear to those skilled in the art that further embodiments may be made without departing from the scope of the present invention.

1. A switch device comprising:
a case having an open top and a switch member pivotably engaged with the open top of the case, a connection member connected to the switch member;
a first terminal and a second terminal respectively extending through a bottom of the case, a bimetallic plate having a first end fixed to the first terminal and a first contact point connected to a second end of the bimetallic plate, a second contact point connected to the second terminal and located beneath the first contact point, and
a protection mechanism including a pivotable member which is pivotably connected to the connection member of the switch member, two rods extending from a first side of the pivotable member and a tongue pivotably connected to the pivotable member and located above the two rods, the second end of the bimetallic plate located between the tongue and the two rods:
wherein the second end of the bimetallic plate is lifted by the two rods to set the switch device to “OFF” position when the switch member is pressed on an “OFF” side, the second end of the bimetallic plate is pushed downward by the tongue to set the switch device to “ON” position and the pivotable member is pivoted an angle to move the tongue away from the second end of the bimetallic plate when the switch member is pressed on an “ON” side, and the second end of the bimetallic plate can be deformed upward without being stopped by the tongue when the switch device is in “ON” position amid overloaded.

2. The device as claimed in claim 1, wherein the tongue is shorter than the two rods.

3. The device a*; claimed in claim 1, wherein the connection member has a rod and the pivotable member has a passage defined in an end thereof, the pivotable member pivotably connected to the switch member by inserting the rod of the connection member in the passage.

4. The device as claimed in claim 1, wherein the case includes a first protrusion extending from an inside thereof and the pivotable member includes a second protrusion extending from the first side of the pivotable member thereof, a spring having two ends which are mounted to the first and second protrusions respectively, a convex portion extending from a second side of the pivotable member and the convex portion being forced in contact with an inside of the case by the spring.

5. The device as claimed in claim 4, wherein the pivotable member is pivoted to move the convex portion in a recess in the case when the switch device is in “ON” position, the tongue moved with the pivotable member so that the second end of the metallic plate is not stopped by the tongue.

6. The device as claimed in claim 1, wherein the tongue includes a through hole in one end thereof and a pin extends through the pivotable member and the through hole, the tongue being pivotable in a space defined between the two rods.

7. The device as claimed in claim 1, wherein the pivotable member includes a flange extending from the first side thereof and the tongue is located below the flange so that the flange prevents the tongue from being pivoted upward.
